(19) United States
(12) Patent Application Publication
(10) Pub. No.: US 2011/0168005 A1
(43) Pub. Date: Jul. 14, 2011

(54) GLAZING WITH INCREASED BULLET RESISTANCE

(75) Inventors: Vincent Pluen, Marcilly En Villette (FR); Stephane Leray, Saint Gondon (FR); Francoise Mennechez, Checy (FR)

(73) Assignee: Saint-Gobain Glass France, Courbevoie (FR)

(21) Appl. No.: 12/997,692

(22) PCT Filed: Jun. 11, 2009
(86) PCT No.: PCT/FR2009/051098

§ 371 Date: Mar. 4, 2011

(30) Foreign Application Priority Data
Jun. 12, 2008 (FR) 0853902

(51) Int. Cl. F41H 5/04; B32B 3/18; B32B 17/10

(52) U.S. Cl. 89/36.02; 156/60; 89/904; 89/905; 89/917; 89/906

(57) ABSTRACT

The subject of the invention is:
the use for a transparent bullet-proof and/or splinter-proof laminate, of which at least part of the thickness consists of a mosaic comprising at least two transparent constituent elements, in order to limit deterioration of the laminate beyond one of said at least two constituent elements that receive an impact;
such a laminate with dimensions greater than those that are the maximum possible for a plate of monocrystalline sapphire, of which at least part of the thickness consists of an at least partly transparent mosaic, and of which at least one of its outer faces consists of a continuous transparent sheet;
glazing for a building or transport vehicle comprising this laminate.

The present invention relates to glazing units resistant to bullets and/or splinters and/or projectiles of the same type.

Such glazing units consist of assemblies of glass sheets and a transparent plastic material connected together by adhesive interlayers of the polyvinyl butyral (PVB), polyurethane (PU) or epoxy resin type.

Extremely high levels of bullet resistance may be achieved by increasing the thickness of the laminates, to the detriment of light transmission through the glass.

Some materials, in particular monocrystalline sapphire, cannot be produced in plates or sheets with main areas greater than approximately 225×660 mm². For greater dimensions, consideration may then be given to the association of several plates of identical or different materials in a mosaic. The inventors have discovered that such mosaics are capable of procuring very high levels of ballistic resistance, but also in addition they limit the propagation of deterioration (cracks etc.) of the laminate beyond their constituent part that receives an impact. In other words, deterioration no longer extends over a monolithic sheet with the same surface area and material as those of the mosaic. On the mosaic, there is the tendency in many cases for deterioration to be confined to the constituent (“square”) receiving an impact.

Moreover, it has surprisingly been found that the fine spaces between squares of the mosaic, generally occupied by notably organic joints, in no way constitute a weakness from the point of view of ballistic resistance.

Consequently, the subject of the invention is the use of a transparent bullet-proof and/or splinter-proof laminate, of which at least part of the thickness consists of a mosaic comprising at least two transparent constituent elements, in order to limit deterioration of the laminate beyond one of said at least two constituent elements that receive an impact. The laminate is here transparent in the sense that at least part of its main surface is transparent.

In addition, the inventors observed that the use of a transparent ceramic made it possible to achieve excellent levels of resistance to bullets and/or splinters for minimum mass per unit area of the generally laminated composite, and maximum visible light transmission through this. The terms “minimum” and “maximum” refer to other transparent materials used in this application, in particular glass.

Consequently, in a particular embodiment of the use of the invention, said laminate includes a transparent ceramic in order to reduce the mass per unit area of the laminate with constant resistance to bullets and/or splinters, and to increase the visible light transmission through the laminate.

A transparent ceramic, designated here for example monocrystalline sapphire (AL₂O₃), polycrystalline Al₂O₃, aluminum oxynitride (AlON) and a spinel.

The subject of the invention is also a transparent bullet-proof and/or splinter-proof laminate with dimensions greater than those that are the maximum possible for a plate of monocrystalline sapphire, characterized in that at least part of its thickness consists of a mosaic comprising at least two transparent constituent elements, and in that at least one of its outer faces consists of a continuous transparent sheet.

Thus, said mosaic is prevented from itself forming an outer face of the laminate. In point of fact, irregularities on the surface of the mosaic may be a source of more or less long-term soiling, or the catching of a cleaning tool such as a windscreen wiper etc. Soiling of organic seals of the PVB type is in particular prevented and their durability is increased by limiting their deterioration by UV and moisture.

According to two embodiments that are not mutually exclusive:
one said continuous transparent sheet is made of glass with a thickness of between 2 and 6 mm, notably made of chemically toughened glass, in a particularly suitable manner on the side where the impact is expected;
one said continuous transparent sheet is made of polycarbonate or the equivalent, preferably on the side opposite that intended to receive the impact.

Said at least two transparent constituent elements may be monolithic, laminated, made of identical or different materials chosen from a ceramic, a glass, a vitroceramic and/or a plastic.

The ceramic employed may be, in a preferred manner, monocrystalline such as monocrystalline sapphire (Al₂O₃), or polycrystalline such as polycrystalline alumina, sintered ceramic, or Al oxynitride (AlON) or a spinel.

The glass employed may be a soda lime glass with a low Fe content, a borosilicate, possibly treated, for example by chemically toughening.

Examples of plastics that may be used are the adhesives polyvinyl butyral (PVB), polyurethane (PU) or polycarbonate (PC), an acrylic such as polymethylmethacrylate (PMMA) or an ionomer resin.

The laminate of the invention has a thickness of between 30 and 120 mm, preferably between 40 and 100 mm.

It consists of rigid, at least partly transparent sheets/mosaics of ceramic, glass, vitroceramic and/or plastic, adhered together by inserted adhesive layers such as PVB or PU.

The thickness of the latter is for example a multiple of 0.38 mm, notably 0.76 mm.

The thickness of the sheets/mosaics of ceramics lies between 2 and 18 mm, and is equal notably to 3.18 mm, 6.35 mm or 7.62 mm and preferably does not exceed 15-17 mm.

The thickness of the sheets/mosaics of glass lies between 2 and 15 mm, preferably between 6 and 12 mm, with the exception of the glass sheet constituting, as the case may be, the outer surface of the laminate of which the thickness is 2 to 6 mm, notably 4 mm.

The thickness of the sheets/mosaics of vitroceramic may lie between 5 and 7 mm.

The thickness of the sheets/mosaics of plastic lies between 2 and 10 mm.

The constituent elements of a mosaic, whether transparent or not, are preferably adhered together by an organic seal, for example by a bead of PVB of 0.38 or 0.76 mm.

The edges have chamfers that are reduced as much as possible, or other forms in shoulders or bevels, which enable the edges of two adjacent constituent elements to fit together and/or overlap. Nevertheless, the straight form without a chamfer or with a chamfer reduced as much as possible is preferred from an optical point of view.

The laminate according to the invention may have a length as great as 2 m for example.

According to two particular embodiments of the laminate of the invention:
said mosaic comprises at least one non-transparent constituent element, notably made of a bullet-proof and/or splinter-proof material, for example metallic;
a penetrating insert made of a bullet-proof and/or splinter-proof material is incorporated in the laminate covering the periphery of the bullet-proof and/or splinter-proof structure of the laminate, and also designed to cover, in the position in which this is mounted, the aperture in which it is installed: in this respect, reference is made to patent EP 918 629 B1.

The subject of the invention is also a glazing unit for a building or transport vehicle (terrestrial, aquatic, air, space) comprising a laminate described above.

The invention will be better understood in light of the following example.

### EXAMPLE

A laminate is employed with the following composition:

4 white glass/1.52 PVB/7.62 sapphire/1.52 PVB/7.62 sapphire/1.52 PVB/12 white glass/0.76 PVB/12 white glass/0.76 PVB/12 white glass/0.76 PVB/12 white glass/0.76 PVB/3 white glass/2.5 PU/3 PC

in which the figures indicate the thickness of the constituents, sapphire is monocrystalline, PVB denotes polyvinyl butyral, PU denotes polyurethane and PC polycarbonate.

Each of the sapphire thicknesses consists of a mosaic of 100 mm×100 mm squares adhered together by 0.76 mm beads of PVB.

The edges of these squares have chamfers less than 0.5 mm.

This laminate has a thickness of 82 mm, a mass per surface area of 210 kg/m² and a visible light transmission greater than 70%.

It satisfies the NATO-STANAG (North Atlantic Treaty Organization—Standard Agreement) standard 4569 of level 4,
a) as well as for 14.5×114 API B32 ammunition emitted at 911 m/s
b) as well as for FSP 20 mm fragments emitted at 960 m/s.

In both cases a) and b), it is found that deterioration of the laminate is limited to beyond the sapphire square having received the impact.

Glass laminates without a sapphire-type ceramic, have, for the same ballistic resistance
a thickness greater than 130 mm, a mass per unit area greater than 320 kg/m² and a visible light transmission less than 50% in the case of a) above, and
a thickness greater than 100 mm, a mass per unit area greater than 250 kg/m² and a visible light transmission less than 58% in the case of b) above.

The seals between the squares are not a weakness for the laminate, which resists shots on these seals as if the mosaic had been replaced by a monolithic sapphire sheet.

1. A method of limiting deterioration of a transparent bullet-proof and/or splinter-proof laminate subject to an impact, the method comprising combining at least a first transparent constituent element and a second transparent constituent element into a mosaic, within at least part of the thickness of the laminate, thereby limiting deterioration of the laminate beyond one of said at least first and second constituent elements that receives the impact, wherein at least one outer face of the laminate of comprises a continuous transparent sheet over the outer face, so that said mosaic is not the outer face of the laminate.

2. The method of claim 1, wherein said laminate further comprises a transparent ceramic which reduces mass per unit area of the laminate with constant resistance to bullets and/or splinters, and increases visible light transmission through the laminate.

3. A transparent bullet-proof and/or splinter-proof laminate comprising, in at least part of a thickness of the laminate, a mosaic comprising at least two transparent constituent elements, and
upon at least one outer face of the laminate, a continuous transparent sheet so that said mosaic is not the at least one outer face of the laminate
wherein dimensions of the laminate are greater than maximum possible dimensions for a plate of monocrystalline sapphire.

4. The laminate of claim 3, characterized wherein said continuous transparent sheet comprises glass with a thickness of between 2 and 6 mm.

5. The laminate of claim 3, wherein said continuous transparent sheet comprises a polycarbonate or an equivalent of polycarbonate.

6. The laminate of claim 3, wherein said at least two transparent constituent elements comprise at least one identical or different material selected from the group consisting of a ceramic, a glass, a vitroceramic, and a plastic.

7. The laminate of claim 3, wherein said mosaic comprises at least one non-transparent constituent element.

8. The laminate of claim 3, wherein a penetrating insert comprising a bullet-proof and/or splinter-proof material is incorporated into the laminate, covering a periphery of the bullet-proof and/or splinter-proof laminate, and also covering, in a position in which the laminate is mounted, an aperture in which the laminate is installed.

9. A glazing, comprising the laminate of claim 3.

10. The laminate of claim 4, wherein the glass is a chemically toughened glass.

11. The laminate of claim 4, wherein said continuous transparent sheet comprises a polycarbonate.

12. The laminate of claim 4, wherein said at least two transparent constituent elements comprise at least one identical or different material selected from the group consisting of a ceramic, a glass, a vitroceramic, and a plastic.

13. The laminate of claim 10, wherein said at least two transparent constituent elements comprise at least one identical or different material selected from the group consisting of a ceramic, a glass, a vitroceramic, and a plastic.

14. The laminate of claim 5, wherein said at least two transparent constituent elements comprise at least one identical or different material selected from the group consisting of a ceramic, a glass, a vitroceramic, and a plastic.

15. The laminate of claim 11, wherein said at least two transparent constituent elements comprise at least one identical or different material selected from the group consisting of a ceramic, a glass, a vitroceramic, and a plastic.

16. The laminate of claim 4, wherein said mosaic comprises at least one non-transparent constituent element.

17. The laminate of claim 10, wherein said mosaic comprises at least one non-transparent constituent element.

18. The laminate of claim 5, wherein said mosaic comprises at least one non-transparent constituent element.

19. The laminate of claim 11, wherein said mosaic comprises at least one non-transparent constituent element.

20. The laminate of claim 7, wherein the at least one non-transparent constituent element comprises a bullet-proof and/or splinter-proof material.
